(19) United States
(12) Patent Application Publication
(10) Pub. No.: US 2017/0262913 A1
(43) Pub. Date: Sep. 14, 2017

(54) WISH LIST SHARING AND PUSH SUBSCRIPTION SYSTEM

(71) Applicant: PAYPAL, INC., San Jose, CA (US)

(72) Inventors: Wai Kei So, Daly City, CA (US); Chauthuy Fritsch, Castro, CA (US)

(21) Appl. No.: 15/606,429

(22) Filed: May 26, 2017

Related U.S. Application Data
(63) Continuation of application No. 14/749,211, filed on Jun. 24, 2015.
Application No. 14/749,211 is a continuation of application No. 13/525,832, filed on Jun. 18, 2012, now abandoned.
(60) Provisional application No. 61/554,360, filed on Nov. 1, 2011.

(51) Int. Cl. G06Q 30/06; G06F 17/30; G06Q 30/02

(52) U.S. Cl. CPC G06Q 30/0611; G06Q 30/02; G06Q 30/0633; G06F 17/30879

(57) ABSTRACT

Methods and systems for making competitive sales or incentive offers from merchants through a service provider to a user while protecting user privacy enable merchants to make offers that are based on a user shopping wish list—which may be either transient (having a pre-set expiration time) or non-transient—in which the wish lists are provided from users through the service provider to merchants in a secure and private manner. A computer-implemented method includes: sending, to a merchant device of a merchant, some wish list data about a wish list item for a user, the wish list data containing no specifically identifying information about the user; receiving, by a service provider device of a service provider, an offer about the wish list item from the merchant based on the wish list data; and providing, to a user device for the user, the offer about the wish list item.

### CROSS REFERENCE TO RELATED APPLICATIONS

This application is a continuation of U.S. patent application Ser. No. 14/749,211, filed Jun. 24, 2015, which is a continuation of U.S. patent application Ser. No. 13/525,832, filed Jun. 18, 2012, which claims priority from U.S. Provisional Application No. 61/554,360 filed on Nov. 1, 2011, all of which are incorporated herein by reference.

### BACKGROUND

Technical Field

Embodiments of the present invention generally relate to commerce using a communication network such as the Internet and, more particularly, to providing users of mobile devices, through a service provider, comparison shopping and information sharing techniques that have advantages for both shoppers and merchants.

Related Art

In a generally familiar process of online commerce, also referred to as e-commerce or online shopping, a consumer, using a mobile phone or computing device, may find a product of interest either directly by visiting the website of a retailer or indirectly by searching among alternative vendors using a shopping search engine.

In one scenario, online retailers use shopping cart software to allow the consumer to select the product of interest, to accumulate multiple items, and to adjust quantities, analogous to filling a physical shopping cart or basket in a conventional store. Typically, a “checkout” process allows the consumer to make payment and provide delivery information. Many online stores allow consumers to sign up for an online account with the store so that some or all of this information only needs to be entered once. Often, such an account allows the consumer to maintain a shopping list, or wish list with the store, that may contain various items selected by the consumer that are available from the store with, for example, the price of each item and a link to the item on the store's website.

In another scenario, a consumer may be shopping at a conventional (e.g., “brick and mortar”) store or shopping mall and may use a mobile device (e.g., smart phone or computing device such as a tablet) to do comparison shopping. For example, when a shopper visits a store at a mall, the shopper may locate a desired item and scan it with the mobile device or otherwise enter information about the item into the mobile device. The shopper may then be able to find more information on the item, for example, by searching for the item using a browser on the mobile device or by visiting a comparison shopping website that provides sale information from several merchants. The shopper may use the acquired information about the item to make a decision, for example, to buy the item immediately or go to another store to buy the item. It is the shopper, however, that takes action on the acquired information, which may be described as a “pull” approach in which the shopper (e.g., consumer) pulls information such as price and item descriptions relatively directly from known sources (e.g., browser search engine, comparison shopping website) and then decides what to do with the information.

### SUMMARY

According to one or more embodiments of the present invention, methods and systems are disclosed for a user to receive competitive sales or incentive offers from merchants through a service provider based on a shopping wish list of the user provided to merchants using a subscription service of the service provider. The service provider, while protecting users' private information, may provide wish list information, either individually or in aggregate, to various merchants, e.g., those signed up with the service provider to receive such information. Merchants may make sale offers based on the wish list information to the user or users through the service provider so that users' private information may be protected by the service provider. For example, merchants can make an individual offer through the service provider to a user at a cost lower than a price indicated on the wish list. Also for example, the service provider may aggregate the same or similar items from multiple users so that merchants can make a group offer or individual offers through the service provider based on the aggregate item and price data from the lists. According to one or more embodiments, a “push” subscription system allows merchants to subscribe to a service provider to receive transient wish lists from shoppers, through the service provider, so that merchants may make competing offers to each shopper (through the service provider in a secure and private manner) within a time limit for expiration of the transient wish list set by each shopper.

In one or more embodiments, a system includes: a processor configured to communicate over a network with a user device and with a merchant device of a merchant; and a data storage device including a computer-readable medium having computer readable code for instructing the processor, and when executed by the processor performs operations including: sending, by the processor to the merchant device, wish list data about a wish list item for a user, in which the wish list data contains no specifically identifying information about the user; receiving, by the processor, an offer about the wish list item from the merchant, the offer based on the wish list data; and providing, to the user device for the user, the offer about the wish list item.

In another embodiment, a device-implemented method includes: sending, by a service provider device of a service provider to a merchant device of a merchant, wish list data about a wish list item for a user, in which the wish list data contains no specifically identifying information about the user; receiving, by the service provider device, an offer about the wish list item from the merchant based on the wish list data; and providing, to a user device for the user, the offer about the wish list item.

In a further embodiment, a computer program product comprises a non-transitory computer readable medium having computer readable and executable code for instructing a processor to perform a method that includes: sending, to a merchant device of a merchant, wish list data about a wish list item for a user, in which the wish list data contains no specifically identifying information about the user; receiving an offer about the wish list item from the merchant based on the wish list data; and providing, to a user device for the user, the offer about the wish list item.

### BRIEF DESCRIPTION OF THE DRAWINGS

FIG. 1 is a system diagram illustrating a system for electronically providing shopping services in accordance with one or more embodiments of the present invention.

FIG. 2 is a flow chart illustrating a method for providing wish list sharing services in accordance with an embodiment.

FIG. 3 is a flow chart illustrating a method for providing push, subscription shopping services in accordance with an embodiment.

### DETAILED DESCRIPTION

Embodiments of the present invention provide systems and methods for merchants to receive consumer information, in a confidential manner that protects consumer privacy, which enables merchants to convey sale offers on items in a consumer's wish list or shopping list (referred to generally as a “wish list”).

In one embodiment, a user may create a wish list through a service provider (e.g., on the service provider's website) by scanning items, or otherwise finding items, for example, through online searches or visiting merchant websites, and adding the items to the wish list, which may be configured to indicate a purchase price or low price for each item. The service provider may provide the information from an individual wish list or from an aggregate of several wish lists to a group of merchants, e.g., merchants subscribing to a wish list information service of the service provider, and merchants receiving the wish list information may, for example, make offers through the service provider for the sale of items on the wish list to the user or a group of users. For example, a merchant or group of merchants may make a sale offer (such as through coupons) to an individual user at a price lower than the price indicated on the individual wish list. For another example, a merchant or group of merchants may make sale offers for items from an aggregate list, based on each item and its price on the list, through the service provider to a group of individuals. The service provider may also offer a number of additional services; for example, each individual consumer may be able to accept their offer through the service provider and may also be able to pay for the purchase through the service provider. Such services may include, for example, an online payment service operating between consumers and merchants and may be a service provided by a financial service provider (FSP)—such as PayPal, Inc. of San Jose, Calif.—in which a user of the service may have an account with the FSP (referred to as an “FSP account).

In another embodiment, a shopper (who may be a user of service provider services) visiting a store for potentially making a purchase may—instead of, or in addition to, the usual comparison shopping with a mobile device, e.g., using browsers, search engines, or scanning a barcode or QR (quick response) code on a product or in-store display for a product—update a transient wish list with one or more items and set a time limit for the transient wish so that the shopper may be notified, within the time limit and in a secure and private manner, of any sale or incentive offers on the item by any shop that receives the transient wish list and wants to compete for the shopper's business. One or more embodiments may include a subscription system in which shops (e.g., merchants) may subscribe to the service provider to receive transient wish list information, which may be provided by the service provider in a manner that protects user's individual privacy. Thus, embodiments may provide a “push” approach in contrast to the “pull” approach described above, in which, for example, the best shoppers can currently do is scan (or input) an item to find more information on the item and it is the shopper who takes action on the acquired information; in other words, the shopper's inquiry does not affect the results of the inquiry. By way of contrast, one or more embodiments provide a “push” approach in which the transient wish list may be uploaded to a service provider that can provide the wish list to appropriate (e.g., by subscription) merchants, the merchants can take action on the information such as deciding to make competing sale or incentive offers, the service provider can receive and filter information such as competing offers and incentives, and “push” the information back to the shopper so that the shopper's inquiry (e.g., wish list) does affect the results of the inquiry.

Embodiments may offer a new type of shopping experience that people do not currently have available. In such an experience, a user (e.g., shopper) may, for example, tell a system what the user currently plans to buy at the user's current location and at what price and give other (e.g., subscribing) retailers a set period of time to respond with a competing offer. Such competing offers may depend, for example, on the locations of the other retailers as well as that of the shopper. Embodiments may enable both retailers and merchants to benefit greatly from knowing about a potential transaction they wouldn't otherwise be aware of. Embodiments may likewise enable shoppers to benefit greatly from being able to get better deals, tailored just to them. For example, a merchant may be able to increase the likelihood of sales, while a consumer may be presented with lower prices or better deals for items on the consumer's wish list. Thus, shoppers may have a better experience when shopping because they are offered more choices, and a merchant may appreciate having an opportunity to make a sale the merchant would otherwise not be aware of, for example, by virtue of being able to make an offer to a shopper for a more reasonable price compared to what the shopper is seeing.

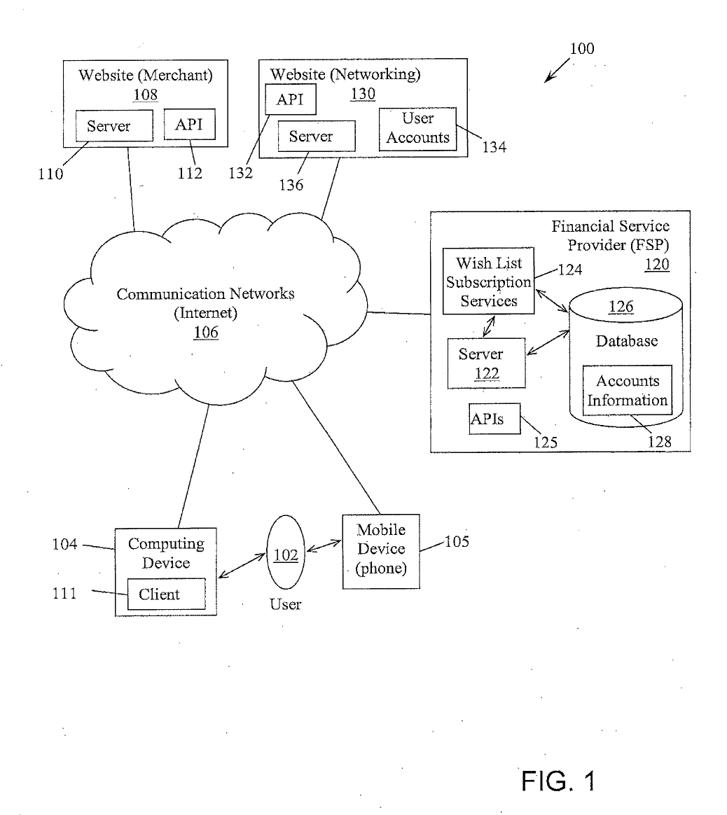

FIG. 1 illustrates a system 100 for online commerce according to one embodiment. A user 102 (generally a shopper or consumer user of FSP services) may communicate via a computing device 104 (e.g., a computer, cell phone, computing tablet, or other consumer electronic device) with financial service provider (FSP) 120 via communication networks 106, which may include the Internet as well as phone networks such as Public Switched Telephone Network (PSTN). User 102 may also communicate over communication networks 106 using a mobile device 105, e.g., a mobile phone of any kind, that can receive messages such as Short Message Service (SMS) messages. User 102 may also communicate via network 106 with a website 108 that may be a merchant website that is a seller of retail goods, for example. Merchant website 108 may sell goods online and may communicate with user 102, for example, by operating a server 110 (e.g., a computer processor) that presents a website for selling goods. The server 110 may respond to client devices (e.g., client 111 running on device 104) by communicating over network 106. In general, for purposes of embodiments described herein, computing device 104 and mobile device 105 need not be separate devices, although they can be, and may be the same device such as embodied by a smart phone, for example

Merchant website 108 may also communicate (for example, using server 110) with FSP 120 through FSP server 122 over network 106. For example, merchant website 108 may communicate with FSP 120 in the course of various services offered by FSP 120 to merchant website 108, such as payment intermediary between customers (e.g., consumer user 102) of merchant website 108 and merchant website 108 itself For example, merchant website 108 may use an application programming interface (API) 112 that allows it to offer sale of goods in which customers are allowed to make payment through FSP 120, while consumer user 102 may have an account with FSP 120 that allows consumer user 102 to use the FSP 120 for making payments to sellers that allow use of authentication, authorization, and payment services of FSP 120 as a payment intermediary. Merchant website 108 may also have an account with FSP 120, in particular, one that allows merchant website 108 to use wish list subscription services 124 of FSP 120 for receiving user wish list data through FSP 120 and for making offers (including, e.g., sales offers or incentives) through FSP 120 to users (e.g., user 102) of FSP 120. Wish list subscription services 124 of FSP 120 may include, for example, a subscription service for merchants by which merchants can sign up or register to receive transient wish list data timely for making competitive offers to a user 102.

Also as shown in FIG. 1, FSP 120 may provide electronic data storage in the form of database 126. Database 126 may be used to keep track of user's accounts 128 with FSP 120, merchant's accounts with FSP 120, and transactions between customers, merchants, and stores including payments between the various entities, for example. FSP server 122 may execute various application programming interfaces (APIs) that may enable various different types of relationships between FSP 120 and the different parties shown in FIG. 1. For example, in addition to having a user account with FSP 120 that allows user 102 to employ FSP 120 as a payment intermediary, the user account may also allow user 102 to maintain a wish list for various consumer items with FSP 120. Such a wish list may have no set expiration date and may be modifiable as user 102 desires. In another embodiment, the user account may allow user 102 to maintain a transient wish list for various consumer items with FSP 120, in which the transient wish list has a short lifespan determined by an expiration time set by the user 102 upon creation of the transient with list so that the user 102 can expect a response, as further described below, to the transient wish list within the lifespan of the wish list and before the expiration time pre-set by the user 102. The response may be, for example, a response sent by FSP 120 with various sale or incentive offers for items on the transient wish list that are gathered by the FSP 120 from various merchants, such as merchant website 108, and passed on to user 102 through FSP 120 without FSP 120 disclosing any private information of user 102 to the merchants. In addition, FSP may provide various APIs 125 to its customers such as website 108 (e.g., API 112) and website 130 (e.g., API 112) that enable those websites to implement embodiments of user account and user wish list services, and merchant account and wish list data subscription services.

Website 130 may be, for example, a social networking website that enables a user (e.g., user 102) to login to the website and maintain a user account 134 with the website 130. Such a website-specific user account 134 may allow a user 102 to maintain a personal webpage, for example, on website 130 and may allow user 102 to keep a private wish list of user 102 at website 130 that may be shared with “friends”. Website 130 may communicate with FSP 120 and user 102, for example, over communication network 106 via server 136. Website 130 may participate in either a wish list sharing or push wish list data subscription service of FSP 120 through use and customization of an API 132 which may be provided by FSP 120. For example, FSP 120 may provide an API 125 that is customizable to become API 132. Similarly, merchant website 108 may subscribe and participate in wish list data subscription services of FSP 120 through use and customization of an API 125 that is customizable to become API 112 provided by FSP 120.

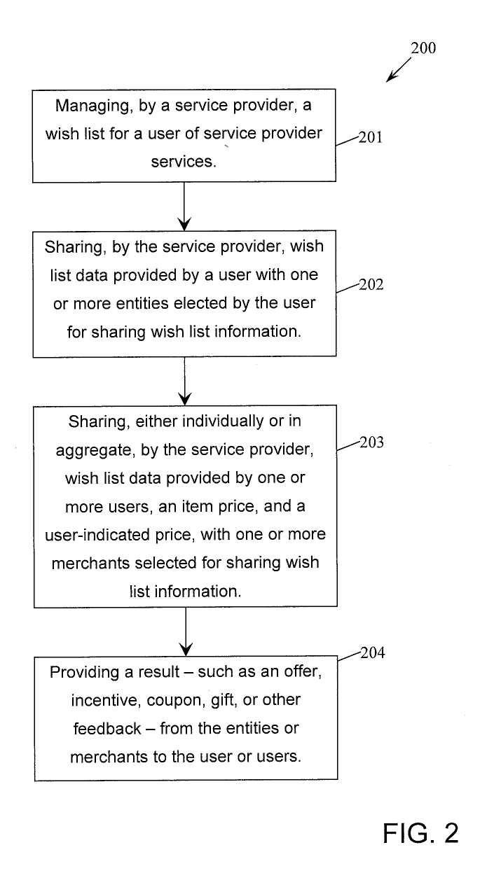

FIG. 2 illustrates a method 200 for providing wish list sharing services in which a consumer may use a service of the service provider that may be subscribed to with the service provider by several merchants. The service may enable a consumer user to maintain a wish list (also referred to as “shopping list”) with the service provider that may include, for example, items and prices for what the user may be planning to buy. The service provider may share, in a manner that respects confidential or sensitive information, the wish list with various merchants, for example, who then may be enabled to provide competing offers for items on the wish list or with the user's social networking site so that friends of the user may be enabled to make suggestions for or gifts of items on the wish list.

At step 201, a service provider (e.g., FSP 120) may manage a wish list or shopping list (generally referred to herein as a wish list) for a user (e.g., user 102) by providing, for example, an interactive display for the user on the service provider's website in response to the user logging in to the user's FSP account. A user may create or add items to the wish list, for example, by searching the Internet using a search engine, visiting a website (e.g., merchant website 108, networking website 130), or using an online marketplace website. For example, the user may enter a product or service description as a search term, and matching items may be presented or displayed to the user. Desired items may then be placed on the wish list managed by the service provider. The service provider may also enable the user to add items to the wish list by scanning, such as through the user's mobile device, information associated with specific products. The product information may be in the form of a barcode, for example, or QR code and attached to an actual product or exhibited on an advertisement or marketing material for the product, such as a print advertisement or in-store display. The service provider may also enable the user to create custom wish list items, for example, a “Trip to Hawaii” may include books, clothes, airline tickets, and hotel accommodations that may grouped together on the wish list maintained with the service provider. The items associated with the “Trip to Hawaii”, for example, may be added using any suitable method, including the ones discussed.

For a non-transient wish list no expiration period may be needed to be chosen by the user, and for a transient wish list an expiration time may be chosen and set by the user to let offer makers know that the user may make a choice, once the expiration time has passed, that precludes or moots further offers. In other words, offers may be considered as being “too late” once the transient wish list expiration time has passed. Items from a wish list may be removed by the service provider once an item is purchased by the user or for the user.

At step 202, the service provider (e.g., FSP 120) may, once the wish list is created, enable the user 102 to elect to share one or more items of the wish list with others, such as friends or relatives through a social network, e.g., via social networking website 130. Sharing on a user's networking website webpage may allow the user to receive feedback on items, comments, suggestions, and offers from persons or entities linked to the user's networking webpage. The user 102 may also receive an actual item purchased by a friend or other entity linked to the user's webpage. Those who can view the user's wish list on the networking webpage may be able to exercise options to purchase one or more items or to contribute to the purchase of one or more items on the user's wish list. For the latter, a friend having an account with the service provider may contribute a portion of the total price of the item and have that portion automatically sent to the user's account with the service provider. Equivalent funds may be debited from the service provider account of the friend. A notification or message (e.g., “you have received a gift”) may also be sent to the user.

At step 203, a service provider (e.g., FSP 120) may enable the user 102 to choose to share one or more items from the wish list with various merchants. The user's choosing to share may then allow the service provider to send wish list data about the items or list to one or more merchants so that each merchant can then determine whether to make an offer to the user.

The service provider may keep the identity or contact information, e.g., specifically identifying information of the user confidential so that the merchant cannot contact the user directly. Such specifically identifying information may include, for example, the user's name, address, social security or driver's license number, phone number, or a combination of personal attributes—such as residence, age, gender, height, weight, or financial information—that could be used together to deduce a specific personal identification.

Given an election to share wish list information from one or more users, the service provider 120 may match offers from merchants (e.g., a merchant operating website 108) to wish list items from users and provide users with the various merchant information, offers, or incentives. The user 102 may also have the option of allowing user information to be communicated to the merchant or merchants.

The service provider 120 may also aggregate data from a plurality of user wish lists to find common items. Information about those items may be provided to one or more merchants. Merchants may then provide offers, coupons, or other incentives to the service provider 120, who may then convey the offers to one or more users 102 having interest in the incentives or items offered.

At step 204, a service provider (e.g., FSP 120) may, once a merchant (e.g., a merchant operating website 108) has information about an item of interest to one or more users (e.g., user 102), communicate an offer or one or more incentives, made by the merchant, to the user. For example, the merchant may offer the user a lower price than what is currently available through an online search. The merchant may also offer the user a coupon for a discount for the item if the user makes another purchase from the merchant, such as an item purchase for a minimum price. The merchant may offer other types of incentives in an attempt to convince the user to make a purchase with the merchant, even if the incentive is not tied directly with the wish list item. The service provider may provide suitable merchant offers to the user through for example, the user's smart phone, computing tablet, PC, or other computing or communication device.

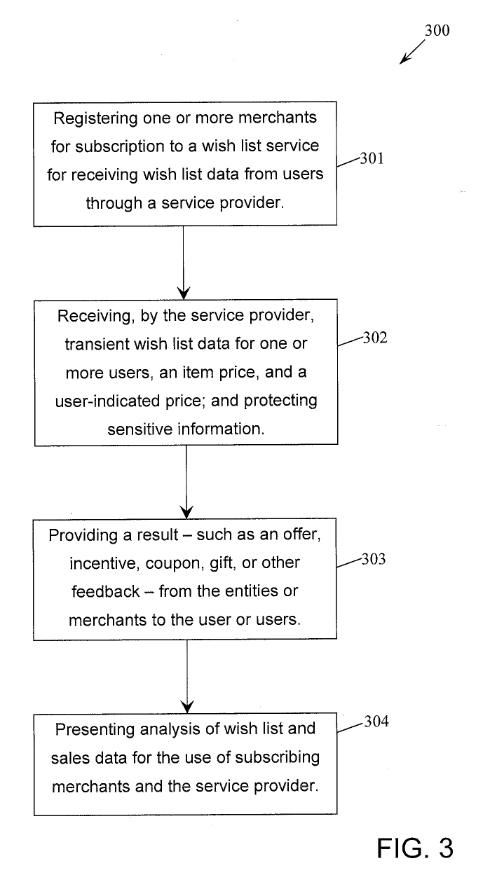

FIG. 3 illustrates a method 300 for providing push, subscription shopping services between a consumer and merchants through a service provider in which a consumer may use a service of the service provider that is subscribed to by merchants with the service provider. The service may enable a user to inform the service provider what the user currently plans to buy at the user's current location and at what price so that subscribing merchants have an opportunity to “push” competing offer information back to the user, confidentially, through the service provider. The service may allow the user to set a time limit, e.g., expiration time, for receiving the offer information.

At step 301, a service provider (e.g., FSP 120) may provide a secure computing platform (e.g., wish list subscription services 124 executed on server 122 and supported by database 126) that operates a subscription service in which various merchants who have signed up to be notified by the subscription service may receive wish list data of users (e.g., user 102) through service provider 120. Registering merchants for the subscription service may include acquiring information detailing the items the merchants sell, price range, location of their stores, and which items are in which stores. Registered merchants may be verified by the computing platform of the subscription service and given access via an access control list, for example, to be notified of transient wish lists that are newly created, as they are created.

At step 302, when, for example, a shopper (e.g., user 102) visits a store at a mall, the shopper may locate an item the shopper desires and scan it with the shopper's mobile device (e.g., mobile device 105 or computing device 104). In response to scanning the item (or advertisement or item display), the item, its price, and the location of the shopper may be uploaded to the secure computing platform (e.g., wish list subscription services 124, server 122, and database 126 of FSP 120) of the wish list subscription service (e.g., wish list subscription services 124), and stored as a “transient wish list”. The user's transient wish list may contain transient information, such as the shopper's location. The transient wish list may exist for a pre-determined life span, e.g., some particular number of minutes, a number configurable by the shopper, e.g., user 102, that determines an expiration time for the transient wish list. The life span (e.g., number of minutes or other time period) may be pre-set by the shopper for any number of transient wish lists or set by the shopper each time or for each transient wish list and may also be expressed, for example, as a particular cut-off time, e.g., clock time such as 3:15 p.m. Because the transient wish list on the secure computing platform may contain sensitive information, e.g. the shopper's location, and items the shopper is looking at, or other specifically identifying information as described above, the transient wish list may be stored as private and read-only. Before actually making the purchase, the shopper may continue shopping or otherwise wait out the expiration time of the transient wish list, at which time the shopper may conclude that any offers by merchants for items on the transient wish list will have been received and that the shopper may stop waiting for any further offers.

Thus, at step 303, prior to the shopper, e.g., user 102, making a purchase, and within the duration of the n-minute life span (configured or set by the consumer, user 102) of the transient wish list, each merchant (e.g., merchant operating website 108) who has signed up for the wish list subscription service (e.g., wish list subscription services 124), may have an opportunity to make a better offer to the shopper, user 102, for the same, or a similar, item. Moreover, the merchants may be able to evaluate the likelihood of what price to offer given the shopper's location versus the merchant's own store and item location, and how likely the shopper may be to make the trip to the merchant's item's location to buy it there. Also, for example, even if the store is in another state or country, the store may make on offer based on an evaluation of the user's willingness to wait for the item to be shipped or make an extra incentive such as free shipping.

At step 304, a service provider (e.g., FSP 120) may, using the history of the creation of the transient wish lists, for example, perform analysis of shared wish list, transient wish list, and sales data from the wish list subscription service (e.g., wish list subscription services 124). For example, service provider, FSP 120, may rank shoppers' buying behavior and rank shoppers in terms of what types of items and in what price ranges items may be purchased. Analysis of wish list and sales data may be considered reliable as a result of obtaining a large number of data points from shopper users 102, and a reliable number of data points may be generated as a result of shoppers being motivated—for example, by creating more opportunities for merchants to make better deals with shoppers—to use the wish list service (e.g., for wish list sharing or for transient wish lists). By having a large number of data points, the service provider may be able to provide reliable analysis results, for use by both the merchants and service provider, for example, to make recommendations to the merchants of what a likely offer price would be in order to pre-empt the sale of the item the shopper has scanned or, for example, how to better provide products to customers.

In implementation of the various embodiments, embodiments of the invention may comprise a personal computing device, such as a personal computer, laptop, PDA, cellular phone or other personal computing or communication devices. The payment provider system may comprise a network computing device, such as a server or a plurality of servers, computers, or processors, combined to define a computer system or network to provide the payment services provided by a payment provider system.

In this regard, a computer system may include a bus or other communication mechanism for communicating information, which interconnects subsystems and components, such as a processing component (e.g., processor, micro-controller, digital signal processor (DSP), etc.), a system memory component (e.g., RAM), a static storage component (e.g., ROM), a disk drive component (e.g., magnetic or optical), a network interface component (e.g., modem or Ethernet card), a display component (e.g., CRT or LCD), an input component (e.g., keyboard or keypad), and/or cursor control component (e.g., mouse or trackball). In one embodiment, a disk drive component may comprise a database having one or more disk drive components.

The computer system may perform specific operations by processor and executing one or more sequences of one or more instructions contained in a system memory component. Such instructions may be read into the system memory component from another computer readable medium, such as static storage component or disk drive component. In other embodiments, hard-wired circuitry may be used in place of or in combination with software instructions to implement the invention.

Logic may be encoded in a computer readable and executable medium, which may refer to any medium that participates in providing instructions to the processor for execution. Such a medium may take many forms, including but not limited to, non-volatile media, volatile media, and transmission media. In one embodiment, the computer readable medium is non-transitory. In various implementations, non-volatile media includes optical or magnetic disks, such as disk drive component, volatile media includes dynamic memory, such as system memory component, and transmission media includes coaxial cables, copper wire, and fiber optics, including wires that comprise bus. In one example, transmission media may take the form of acoustic or light waves, such as those generated during radio wave and infrared data communications.

Some common forms of computer readable and executable media include, for example, floppy disk, flexible disk, hard disk, magnetic tape, any other magnetic medium, CD-ROM, any other optical medium, punch cards, paper tape, any other physical medium with patterns of holes, RAM, ROM, E2PROM, FLASH-EPROM, any other memory chip or cartridge, carrier wave, or any other medium from which a computer is adapted to read.

In various embodiments, execution of instruction sequences for practicing the invention may be performed by a computer system. In various other embodiments, a plurality of computer systems coupled by a communication link (e.g., LAN, WLAN, PTSN, or various other wired or wireless networks) may perform instruction sequences to practice the invention in coordination with one another.

Modules described herein can be embodied in one or more computer readable media or be in communication with one or more processors to execute or process the steps described herein.

A computer system may transmit and receive messages, data, information and instructions, including one or more programs (i.e., application code) through a communication link and a communication interface. Received program code may be executed by a processor as received and/or stored in a disk drive component or some other non-volatile storage component for execution.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa—for example, a virtual Secure Element (vSE) implementation or a logical hardware implementation.

Software, in accordance with the present disclosure, such as program code and/or data, may be stored on one or more computer readable and executable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present invention to the precise forms or particular fields of use disclosed. It is contemplated that various alternate embodiments and/or modifications to the present invention, whether explicitly described or implied herein, are possible in light of the disclosure. Having thus described various example embodiments of the disclosure, persons of ordinary skill in the art will recognize that changes may be made in form and detail without departing from the scope of the invention. Thus, the invention is limited only by the claims.

What is claimed is:

1. A system comprising:
a non-transitory memory; and
one or more hardware processors coupled to the non-transitory memory and configured to read instructions from the non-transitory memory to cause the system to perform operations comprising:
in response to an item being scanned using a user device and a user-indicated price for the item being entered into the user device by a user, uploading from the user device to a secure computing platform a user location associated with a sale of the item to the user, a scanned price of the item, the user-indicated price of the item, and a pre-set expiration time for merchants to respond to the user;
in response to the uploading, determining, using a subscription service database comprising item sales and store location information for each of a plurality of subscribing merchants, at least one subscribing merchant providing the item for sale;
sending from the secure computing platform to at least one merchant device of the at least one subscribing merchant information including the scanned price of the item, the user-indicated price of the item, and the pre-set expiration time such that the information enables the at least one subscribing merchant to respond to the secure computing platform with a sale or incentive offer for the item;
sharing, based on user elections by the user, the item on a networking website webpage for the user;
receiving an option to purchase or contribute to the purchase of the item from the at least one subscribing merchant by at least one other user through the networking website webpage;
filtering one or more competing sale and incentive offers for the item from the at least one subscribing merchant based on the user location, the user-indicated price of the item in comparison to the scanned price of the item, and the option, to produce at least one offer specific to the user; and
displaying to the user on the user device the offer specific to the user at the user location within the pre-set expiration time.

2. The system of claim 1, wherein the user location comprises a current location of the user.

3. The system of claim 1, wherein the secure computing platform provides a login for the user.

4. The system of claim 1, wherein the operations further comprise:
determining whether the at least one merchant device has a subscription to a wish list service of a service provide,
wherein sending the information comprises sending the information only to a merchant device of the at least one merchant device having a subscription to the wish list service.

5. The system of claim 1, wherein the operations further comprise:
aggregating data associated with the item in wish lists from multiple users; and
determining, from the data, an aggregated result about the item for the multiple users, wherein the aggregated result excludes identifying information about the multiple users,
wherein sending the information comprises sending the aggregated result to the at least one merchant device.

6. The system of claim 1, wherein the one or more competing sale and incentive offers are received by the secure computing platform from the at least one merchant device.

7. The system of claim 1, wherein the pre-set expiration time is set by the user prior to the uploading.

8. The system of claim 1, wherein the filtering is based on locations of the at least one subscribing merchant.

9. A method comprising:
in response to an item being scanned using a user device and a user-indicated price for the item being entered into the user device by a user, uploading from the user device to a secure computing platform a user location associated with a sale of the item to the user, a scanned price of the item, the user-indicated price of the item, and a pre-set expiration time for merchants to respond to the user;
in response to the uploading, determining, using a subscription service database comprising item sales and store location information for each of a plurality of subscribing merchants, at least one subscribing merchant providing the item for sale;
sending from the secure computing platform to at least one merchant device of the at least one subscribing merchant information including the scanned price of the item, the user-indicated price of the item, and the pre-set expiration time such that the information enables the at least one subscribing merchant to respond to the secure computing platform with a sale or incentive offer for the item;
sharing, based on user elections by the user, the item on a networking website webpage for the user;
receiving an option to purchase or contribute to the purchase of the item from the at least one subscribing merchant by at least one other user through the networking website webpage;
filtering one or more competing sale and incentive offers for the item from the at least one subscribing merchant based on the user location, the user-indicated price of the item in comparison to the scanned price of the item, and the option, to produce at least one offer specific to the user; and
displaying to the user on the user device the offer specific to the user at the user location within the pre-set expiration time.

10. The method of claim 9, wherein the user location comprises a store at a shopping mall.

11. The method of claim 9, wherein the secure computing platform provides a login for the user.

12. The method of claim 9, further comprising:
determining whether the at least one merchant device has a subscription to a wish list service of a service provider,
wherein sending the information comprises sending the information only to a merchant device of the at least one merchant device having a subscription to the wish list service.

13. The method of claim 9, further comprising:
aggregating, by the secure computing platform, data associated with the item in wish lists from multiple users; and
determining, from the data, an aggregated result about the item for the multiple users, wherein the aggregated result excludes identifying information about the multiple users,
wherein sending the information comprises sending the aggregated result.

14. The method of claim 9, wherein the one or more competing sale and incentive offers are received by the secure computing platform from the at least one merchant device.

15. The method of claim 9, further comprising setting the pre-set expiration time according to an input entered into the user device by the user.

16. The method of claim 9, wherein the filtering is further based on locations of the at least one subscribing merchant.

17. The method of claim 9, wherein filtering further comprises rejecting competing sale and incentive offers received after the pre-set expiration time.

18. The method of claim 9, wherein the secure computing platform maintains information associated with the user that includes information about what items the user device has scanned.

19. The method of claim 9, wherein the secure computing platform maintains information associated with the user that includes information about a current location of the user.

20. A non-transitory machine-readable medium having stored thereon machine-readable instructions executable to cause a system to perform operations comprising:
in response to an item being scanned using a user device and a user-indicated price for the item being entered into the user device by a user, uploading from the user device to a secure computing platform a user location associated with a sale of the item to the user, a scanned price of the item, the user-indicated price of the item, and a pre-set expiration time for merchants to respond to the user;
in response to the uploading, determining, using a subscription service database comprising item sales and store location information for each of a plurality of subscribing merchants, at least one subscribing merchant providing the item for sale;
sending from the secure computing platform to at least one merchant device of the at least one subscribing merchant a-information including the scanned price of the item, the user-indicated price of the item, and the pre-set expiration time such that the information enables the at least one subscribing merchant to respond to the secure computing platform with a sale or incentive offer for the item;
sharing, based on user elections by the user, the item on a networking website webpage for the user;
receiving an option to purchase or contribute to the purchase of the item from the at least one subscribing merchant by at least one other user through the networking website webpage;
filtering one or more competing sale and incentive offers for the item from the at least one subscribing merchant based on the user location, the user-indicated price of the item in comparison to the scanned price of the item, and the option, to produce at least one offer specific to the user; and
communicating to the user device within the pre-set expiration time the offer specific to the user at the user location.
